(19) United States
(12) Patent Application Publication
(10) Pub. No.: US 2009/0277053 A1
(43) Pub. Date: Nov. 12, 2009

(54) RECIPE AND RELATED SHOPPING CARD SYSTEM

(76) Inventor: Lauren Critelli, Greenwich, CT (US)

Correspondence Address: MEREDITH & KEYHANI, PLLC, 330 MADISON AVE., 6TH FLOOR, NEW YORK, NY, 10017, US

(21) Appl. No.: 12/116,600

(22) Filed: May 7, 2008

(51) Int. Cl. G09F 3/20; G09F 3/14; G09F 3/18; G09F 3/02

(52) U.S. Cl. 40/27; 40/649; 40/664; 40/654.01

(57) ABSTRACT

A recipe and related shopping card system comprising: at least one sheet having a face and containing at least one recipe imprinted on the face; at least one removable shopping card in removable communication with the face, wherein at least one removable shopping card has a first side and a second side, the first side contains a list of ingredients from a recipe and the second side has at least one of a title, a category of recipe, a group of ingredients and an aisle for ingredients on a second side; at least one attachment means in communication with the removable shopping card; and at least one carrying means for receipt of at least a portion of the attachment means.

The present invention relates to a recipe and related shopping card system. The invention also relates to a method of construction and use of related recipe and shopping cards.

Numerous devices have been proposed for providing recipe cards. Generally, prior art improvements have related to methods of storing recipe cards. A recipe card is usually written by the user and then saved for easy storage and use at a later date, as depicted in FIG. 1 submitted herewith. However, each of the prior art devices are lacking a shopping card component. Accordingly, what is needed is a recipe with a related shopping card. Also, the shopping cards should be easily attached to a carrying means so that a number of shopping cards may be selected for the week, attached to the carrying means and used to obtain the items required to make the recipe.

Another feature lacking in the prior art is a shopping card that is related to a recipe with a list of ingredients grouped together according to category, similar to the manner in which a supermarket is grouped. In this way, the user may use the cards to shop for the required items without constantly monitoring the entire list of ingredients on each card in each supermarket lane.

These and other features, aspects and advantages of the present invention will become better understood with reference to the following description and claims.

### SUMMARY OF THE INVENTION

The present invention relates generally to a recipe and related shopping card system.

According to one embodiment of the present invention, a recipe and related shopping card system is provided comprising: at least one sheet having a face and containing at least one recipe imprinted on the face; at least one removable shopping card in removable communication with the face, wherein the at least one removable shopping card contains a list of ingredients from the at least one recipe on a first side and has at least one attachment means; and at least one carrying means for receipt of at least a portion of the at least one attachment means.

According to another embodiment of the present invention, a recipe and related shopping card system is provided comprising: at least one sheet having a face and containing at least one recipe imprinted on the face; at least one removable shopping card in removable communication with the face, wherein the at least one removable shopping card has a first side and a second side, the first side contains a list of ingredients from the at least one recipe and the second side has at least one of a title, a category of recipe, a group of ingredients and an aisle for ingredients on a second side; at least one attachment means in communication with said at least one removable shopping card; and at least one carrying means for receipt of at least a portion of said at least one attachment means.

According to another embodiment of the present invention, a recipe and related shopping card system comprising: at least one sheet having a face and containing at least one recipe being imprinted on said face; at least one removable shopping card being a portion of said sheet and perforated around an outside edge to be in removable communication with the sheet, wherein the at least one removable shopping card has a first side and a second side, the first side contains a list of ingredients from the at least one recipe and the second side has at least one of a title, a category of recipe, a group of ingredients and an aisle for ingredients imprinted on a second side; at least one attachment means in communication with the at least one removable shopping card; and at least one carrying means for receipt of at least a portion of the at least one attachment means.

These and other features, aspects and advantages of the present invention will become better understood with reference to the following description and claims.

### BRIEF DESCRIPTION OF THE DRAWINGS

FIG. 1 depicts the prior art;

FIG. 2 depicts the present invention;

FIG. 3 depicts the present invention;

FIG. 4 depicts the present invention;

FIG. 5 depicts the present invention;

FIG. 6 depicts the present invention;

FIG. 7 depicts the present invention;

FIG. 8 depicts the present invention;

FIG. 9 depicts the present invention;

FIG. 10 depicts the present invention;

FIG. 11 depicts the present invention;

FIG. 12 depicts the present invention;

FIG. 13 depicts the present invention;

FIG. 14 depicts the present invention;

FIG. 15 depicts the present invention;

FIG. 16 depicts the present invention;

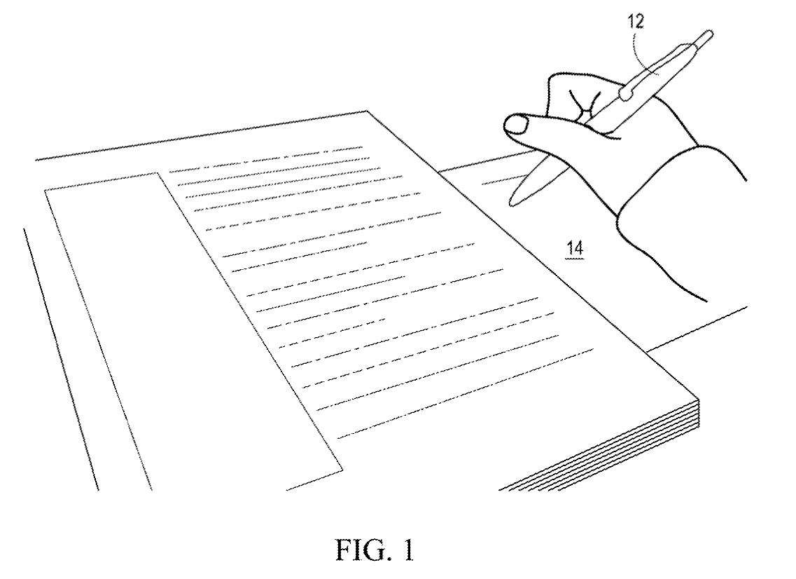

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

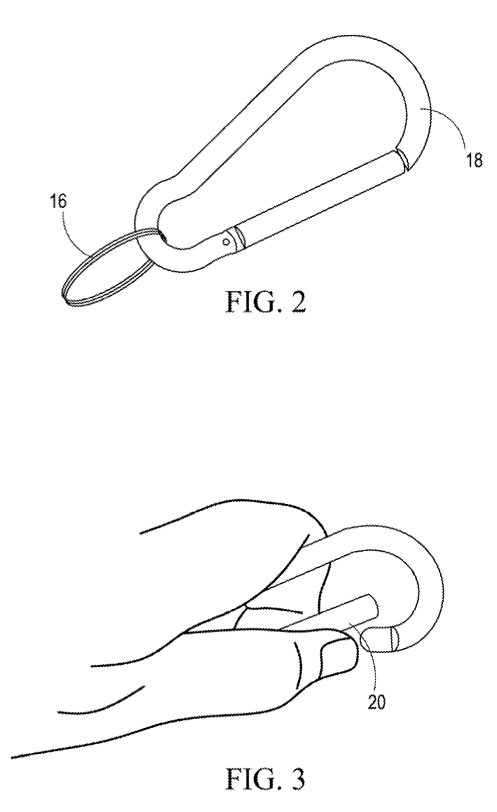

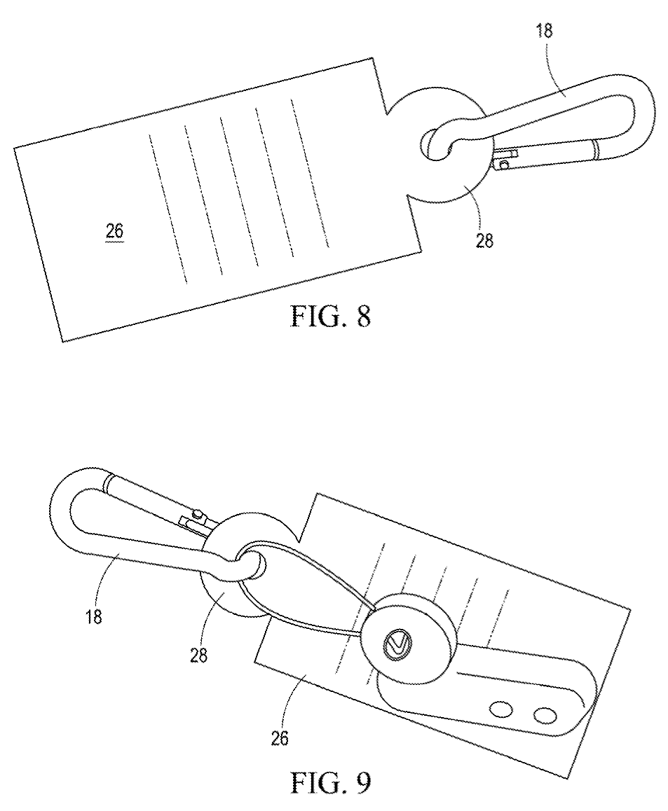

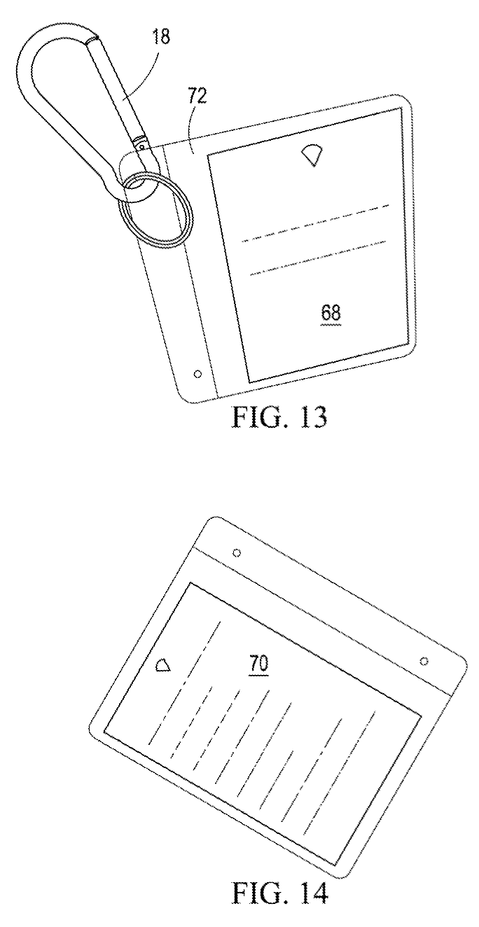

With reference to FIGS. 2-16, the present invention provides a recipe and related shopping card system comprising: at least one sheet (24) having a face (25) and containing at least one recipe (30) imprinted on the face (25); at least one removable shopping card (26) in removable communication with the face (25), wherein the at least one removable shopping card (26) contains a list of ingredients from the at least one recipe on a first side and has at least one attachment means (e.g. 28); and at least one carrying means (18) for receipt of at least a portion of at least one attachment means (e.g. 28). The carrying means may be any suitable connector/carrier such as ring, carabiner, keyring and keyring pocket (72). A carabiner or karabiner is a metal loop with a sprung or screwed gate. The loop part opposite the gate is referred to as the spine. It can quickly and reversibly connect components. The word comes from “Karabinerhaken”, meaning “hook for a carbine” in German. The attachment means may be hole (e.g. 66, 82), reinforced hole, hang tag with a hole (28), and hang tag with a reinforced hole. A reinforced hole may be reinforced along the edge of the hole with a grommet, a piece of plastic or any other reinforcement technique known within the art.

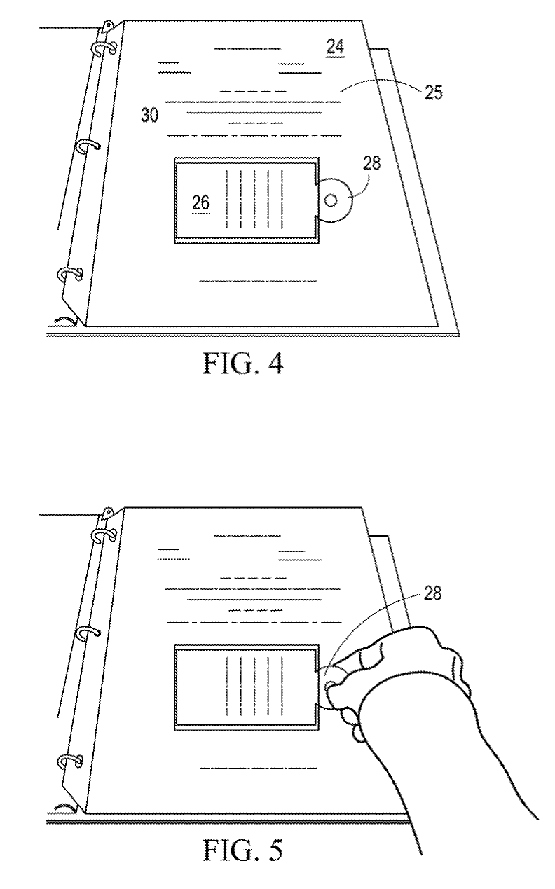

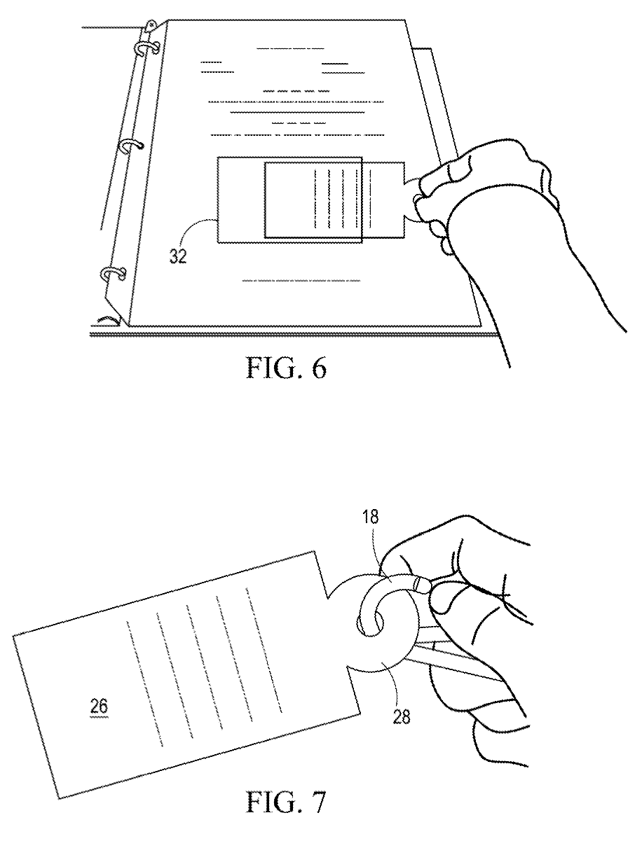

As shown in FIG. 4-6, a recipe and related shopping card system is provided having a transparent, water-resistant cover covering the face and a transparent water resistant pocket having at least two closed sides and at least one open side for the receipt of the at least one removable shopping card. The dotted line in FIG. 6 outlines the transparent, water-resistant pocket to depict it's use. The dotted lines are the lines along which the pocket is sealed. This is particularly useful for reuse of the shopping card and protection of the recipe and card during cooking. Cookbooks can get very dirty due to their proximity to food during cooking. The present invention would overcome this issue by providing a water resistant and transparent cover for the recipe and the shopping card (if desired).

FIG. 7-9 depict a removable shopping card (26) which has a hang tag with a hole (28) and is being attached to a carabiner attachment means for ease of carrying to the supermarket.

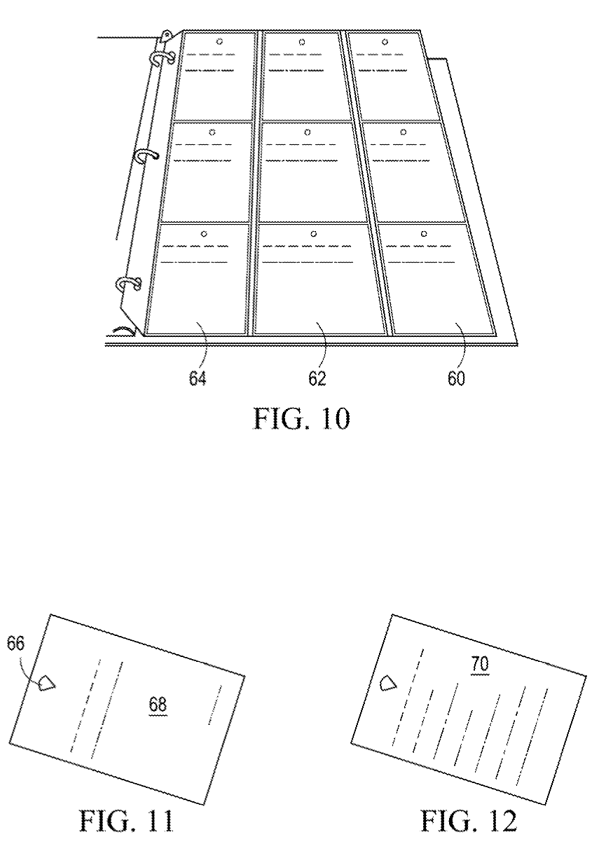

FIG. 10 depicts a plastic cover for storing removable shopping cards (e.g. 60, 62 and 64). FIGS. 11-14 depict another preferred embodiment. According to this embodiment, the removable shopping card (68) has a attachment means that is a hole (66) and a list of ingredients on a first side (70). The carrying means is a keyring pocket (72). In the picture shown, the keyring pocket is made of a water-resistant transparent material. The keyring pocket (72) may hold a single shopping card or a number of shopping cards.

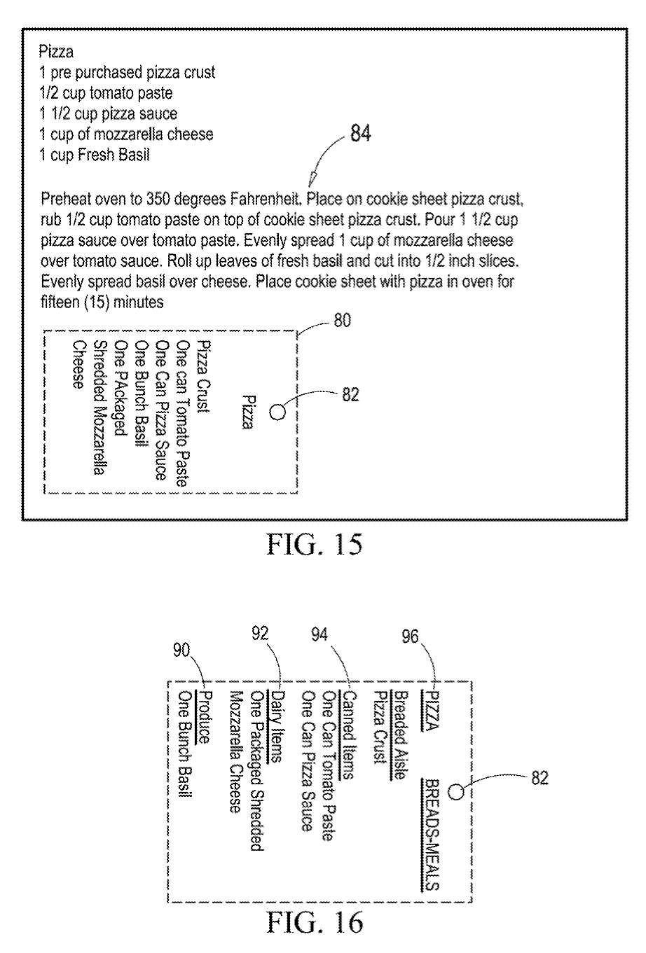

As depicted in FIG. 15, the at least one removable shopping card is perforated along an outside edge in at least a portion of the sheet. It may be desirable to also indicate on the tear away removable shopping card the page in the book that the recipe is on, so that when the user returns home from their shopping trip, they can easily locate the actual recipe. As shown in FIG. 16, the at least one removable shopping card has at least one of a title (e.g. PIZZA), a category of recipe (BREADS-MEALS), a group of ingredients (e.g. Dairy Items)and an aisle for ingredients (Bread Aisle) on a second side. This provides very efficient shopping for the user. They may select seven dinner meals for the week, attach them to their keychain. And when they get to the grocery aisle, as they are standing in Produce quickly scan each of the removable shopping cards items under the title “Produce” and obtain those items.

It should be understood that the foregoing relates to preferred embodiments of the invention and that modifications may be made without departing from the spirit and scope of the invention as set forth in the following claims.

I claim:

1. A recipe and related shopping card system comprising:
at least one sheet having a face and containing at least one recipe imprinted on said face;
at least one removable shopping card in removable communication with said face, wherein said at least one removable shopping card contains a list of ingredients from said at least one recipe on a first side and has at least one attachment means; and
at least one carrying means for receipt of at least a portion of said at least one attachment means.

2. A recipe and related shopping card system as in claim 1, wherein said at least one carrying means is selected from the group consisting of: ring, carabiner, keyring and keyring pocket.

3. A recipe and related shopping card system as in claim 1, wherein said at least one removable shopping card is perforated along an outside edge and is at least a portion of said at least one sheet.

4. A recipe and related shopping card system as in claim 1, further comprising:
a transparent, water-resistant pocket having at least two closed sides and at least one open side for the receipt of said at least one removable shopping card.

5. A recipe and related shopping card system as in claim 1, further comprising:
a transparent, water-resistant layer on top of and in communication with said face of said at least one sheet.

6. A recipe and related shopping card system as in claim 1, wherein said at least one removable shopping card has at least one of a title, a category of recipe, a group of ingredients and an aisle for ingredients on a second side.

7. A recipe and related shopping card system as in claim 1, wherein said attachment means is selected from the group consisting of a hole, reinforced hole, hang tag with a hole, and hang tag with a reinforced hole.

8. A recipe and related shopping card system comprising:
at least one sheet having a face and containing at least one recipe imprinted on said face;
at least one removable shopping card in removable communication with said face, wherein said at least one removable shopping card has a first side and a second side, said first side contains a list of ingredients from said at least one recipe and said second side has at least one of a title, a category of recipe, a group of ingredients and an aisle for ingredients on a second side;
at least one attachment means in communication with said at least one removable shopping card; and
at least one carrying means for receipt of at least a portion of said at least one attachment means.

9. A recipe and related shopping card system as in claim 8, wherein said at least one carrying means is selected from the group consisting of: ring, carabiner, keyring and keyring pocket.

10. A recipe and related shopping card system as in claim 8, wherein said at least one removable shopping card is perforated along an outside edge and is at least a portion of said at least one sheet.

11. A recipe and related shopping card system as in claim 8, further comprising:
a transparent, water-resistant pocket having at least two closed sides and at least one open side for the receipt of said at least one removable shopping card.

12. A recipe and related shopping card system as in claim 8, wherein said attachment means is selected from the group consisting of a hole, reinforced hole, hang tag with a hole, and hang tag with a reinforced hole.

13. A recipe and related shopping card system as in claim 8, further comprising:
a transparent, water-resistant layer on top of and in communication with said face of said at least one sheet.

14. A recipe and related shopping card system comprising:
at least one sheet having a face and containing at least one recipe being imprinted on said face;
at least one removable shopping card being a portion of said sheet and perforated around an outside edge to be in removable communication with said sheet, wherein said at least one removable shopping card has a first side and a second side, said first side contains a list of ingredients from said at least one recipe and said second side has at least one of a title, a category of recipe, a group of ingredients and an aisle for ingredients imprinted on a second side;
at least one attachment means in communication with said at least one removable shopping card; and
at least one carrying means for receipt of at least a portion of said at least one attachment means.

15. A recipe and related shopping card system as in claim 14, wherein said at least one carrying means is selected from the group consisting of: ring, carabiner, keyring and keyring pocket.

16. A recipe and related shopping card system as in claim 14, further comprising:
a transparent, water-resistant pocket having at least two closed sides and at least one open side for the receipt of said at least one removable shopping card.

17. A recipe and related shopping card system as in claim 14, wherein said attachment means is selected from the group consisting of a hole, reinforced hole, hang tag with a hole, and hang tag with a reinforced hole.

18. A recipe and related shopping card system as in claim 14, further comprising:
a transparent, water-resistant layer on top of and in communication with said face of said at least one sheet.
